(19) United States
(12) Patent Application Publication
(10) Pub. No.: US 2017/0221174 A1
(43) Pub. Date: Aug. 3, 2017

(54) GPU DATA SNIFFING AND 3D STREAMING SYSTEM AND METHOD

(71) Applicants: DZUNG DINH KHAC, HANOI (VN); HA VIET NGUYEN, TOKYO (JP); SUMIT GUPTA, LOS ALTOS, CA (US)

(72) Inventors: DZUNG DINH KHAC, HANOI (VN); HA VIET NGUYEN, TOKYO (JP); SUMIT GUPTA, LOS ALTOS, CA (US)

(21) Appl. No.: 15/368,673

(22) Filed: Dec. 5, 2016

Related U.S. Application Data
(60) Provisional application No. 62/289,016, filed on Jan. 29, 2016.

(51) Int. Cl. G06T 1/20; G06T 15/20; A63F 13/50; G06T 1/60

(52) U.S. Cl. CPC G06T 1/20; G06T 1/60; G06T 15/20; A63F 13/50; G06T 2200/04; G09G 5/003

(57) ABSTRACT

In one aspect, a graphics processing unit (GPU) data sniffing method includes the step of providing a video game software comprising a set of graphics data of a video game. The method includes the step of communicating the set of graphics data to a graphics library using an application programming interface (API) call to the graphics library. The graphics library includes at least one application API interface. The method includes the step of providing a sniffing module. The sniffing module intercepts the set of graphics data before the set of graphics data reaches the GPU. The sniffing module copies the set of graphics data to create a copy of the graphics data. The sniffing module forwards the copy of the graphics data to the graphics library for rendering to a receiving entity.

This application is a claims priority to U.S. provisional patent application No. 62/289,016, titled METHOD AND SYSTEM OF 3D STREAMING and filed on 29 Jan. 2016. These provisional applications are hereby incorporated by reference in its entirety.

### BACKGROUND

1. Field

This application relates generally to the computer graphics, and more particularly to a system, method and article of manufacture for GPU data sniffing.

2. Related Art

Streaming and immersive experience (e.g. 3D virtual reality) are emerging trends in game-content market. Both experiences can be provided for viewers at the same time. However, this can raise various challenges when providing an immersive experience (e.g. viewing 3D virtual-reality game) for game viewers via network streaming. Example challenges can include the issue that a current 3D video streaming (e.g. stereoscopic video) technology may be constrained to a player's view angle. This may not provide viewers a full-immersive experience. Also, the bandwidth for streaming a 360-degree video (e.g. for the immersive experience) can exceed a current Internet capacity. Accordingly, this may adversely affect high-quality graphics for viewers. Moreover, in an in-game streaming context, though capable of providing immersive experience for game viewers, may oblige a viewer to have the game software installed on a local computing device. This may limit the viewer's convenience to enjoy various game contents.

### BRIEF SUMMARY OF THE INVENTION

In one aspect, a graphics processing unit (GPU) data sniffing method includes the step of providing a video game software comprising a set of graphics data of a video game. The method includes the step of communicating the set of graphics data to a graphics library implemented in the CPU using an application programming interface (API) call to the graphics library. The graphics library includes at least one application API interface. The method includes the step of providing a sniffing module. The sniffing module intercepts the set of graphics data before the set of graphics data reaches the GPU. The sniffing module copies the set of graphics data to create a copy of the graphics data. The sniffing module forwards the copy of the graphics data to the graphics library for rendering to a receiving entity.

Optionally, the sniffing module can copy only a specified portion of the set of graphics. The receiving entity can include a game player's computing device. The GPU can stream the copy of the graphics data instead of the set of graphics data. The copy of the graphics data comprises 3D graphics data.

### BRIEF DESCRIPTION OF THE DRAWINGS

FIG. 1 illustrates an example system for 3D streaming, according to some embodiments.

FIG. 2 illustrates an example system for implementing a sniffing module, according to some embodiments.

FIG. 3 illustrates an example process for data reduction, according to some embodiments.

FIG. 4 illustrates an example process for identifying a list of objects, according to some embodiments.

FIG. 5 illustrates an example process for identifying a transformation matrix, according to some embodiments.

FIG. 6 illustrates an example process of a 3D encoding algorithm, according to some embodiments.

FIG. 7 illustrates an example of a transmittal module throughput control process, according to some embodiments.

FIG. 8 illustrates an example process that implements a solution to culling in a video game, according to some embodiments.

FIG. 9 illustrates example map construction process(es), according to some embodiments.

FIG. 10 provided an example process of decoding data, according to some embodiments.

FIG. 11 depicts an exemplary computing system that can be configured to perform any one of the processes provided herein.

FIG. 12 is a block diagram of a sample-computing environment that can be utilized to implement various embodiments.

FIG. 13 illustrates an example process for data reduction in a graphics data stream, according to some embodiments.

FIG. 14 illustrates an example process for recognizing static data and motion data, according to some embodiments.

FIG. 15 illustrates an example process for sniffing graphic data, according to some embodiments.

The Figures described above are a representative set, and are not an exhaustive with respect to embodying the invention.

### DESCRIPTION

Disclosed are a system, method, and article of manufacture for GPU data sniffing and three-dimensional (3D) streaming. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

3D (e.g. 3D computer graphics) can refer to a digital representation of three-dimensional space.

Application programming interface (API) can specify how software components of various systems interact with each other.

Caster (or broadcaster) can be a person who broadcasts the game content and gives a running commentary of a game in real time via game Internet streaming services.

FFmpeg can be a software project that produces libraries and programs for handling multimedia data.

Graphics processing unit (GPU) can be a special stream processor used in computer graphics hardware.

Object coordinates can be coordinates with the origin (0,0,0) at a specific point (e.g. the center) of each object.

RGB color space can be any additive color space based on the RGB color model.

Vertex shader can be a program running on the GPU in the rendering pipeline that handles the processing of individual vertices.

View coordinates can be coordinates with the origin at a specific point (e.g. in front) of a digital camera. View coordinates can be the coordinates used to display on monitor and/or VR headset.

Virtual reality (VR) can be an immersive multimedia and/or computer-simulated reality. VR can replicate an environment that simulates a physical presence in places in the real world or an imagined world, allowing the user to interact in that world.

World coordinates can be coordinates with the origin at a specific point (usually the center) of the level map.

YUV can be a color space typically used as part of a color image pipeline. It encodes a color image or video taking human perception into account, allowing reduced bandwidth for chrominance components, thereby typically enabling transmission errors or compression artifacts to be more efficiently masked by the human perception than using a “direct” RGB-representation.

### Example Systems

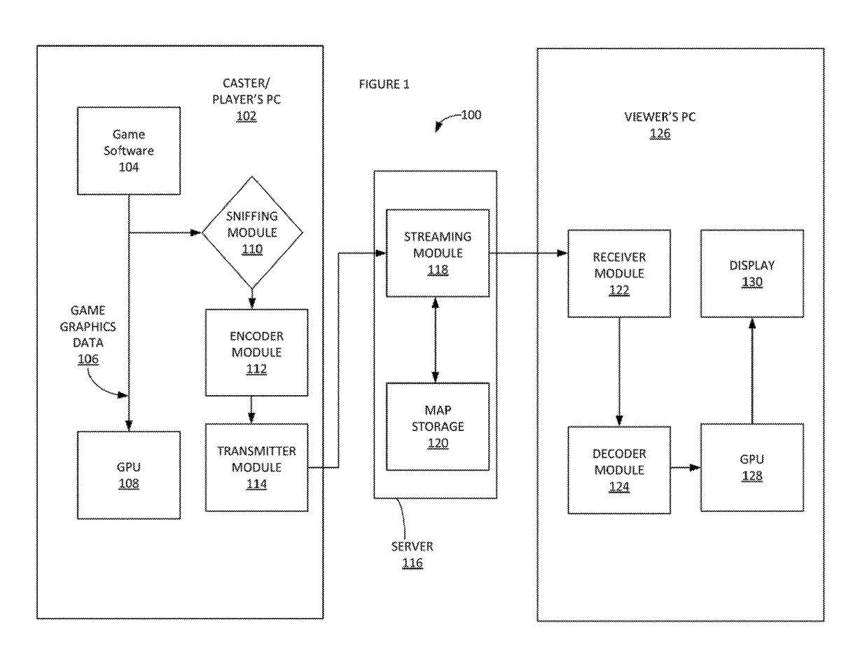

FIG. 1 illustrates an example system 100 for implementing a 3D streaming, according to some embodiments. System 100 can include a caster's and/or player's computing device 102. Computing device 102 can include game software 104. Game software 104 can be used to run a video game. Computing device 102 can include game graphics data 106 provided by game software 104. Game graphics data 106 can be communicated to GPU 108.

Sniffing module 110 can capture (e.g. sniff) game graphics data 106 that the game sends to GPU 108 for rendering, then clone and send the captured data to encoder module 112 (e.g. while keep the data being sent to graphics card). Encoder module 112 can reduce/compress the amount of data to less than ten (10) times or more before sending over the Internet to the streaming server. Transmitter module 112 can render the data for communication over a computer network (e.g. the Internet). Transmitter module 112 can transmit graphics data to server 116.

Server 116 can include streaming module 118 and map storage 120. Streaming module 118 can, inter alia: fill out the data omitted by culling logic of the game software (see infra); implement multicast to multiple viewers; provide handling for viewers joining from the middle of the stream; etc. Map storage 120 can, inter alia: store a map as a collection of objects with world coordinates; remove redundancies (e.g. when the same object with the same world coordinates is stored more than twice); respond to queries (e.g. return the map within a certain range of space); etc. Server 116 can communicate the data to a viewer's PC 126. It is noted that PC (personal computer) can be replaced by other computing devices such as mobile devices, wearable computing systems, virtual-reality head mounted displays, etc.

Viewer's PC 126 can include a receiver module 122. Receiver module 122 can receive the streaming data from streaming server and render it for processing in viewer's PC 126. Decoder module 124 can recover the data encoded by encoder module 112; produce data for high frame rate display from low frame-rate data; send the data to GPU to render for the viewer; etc. The data can then be passed to GPU 128. Display 130 (e.g. a virtual-reality display, etc.) can then display the video-game data.

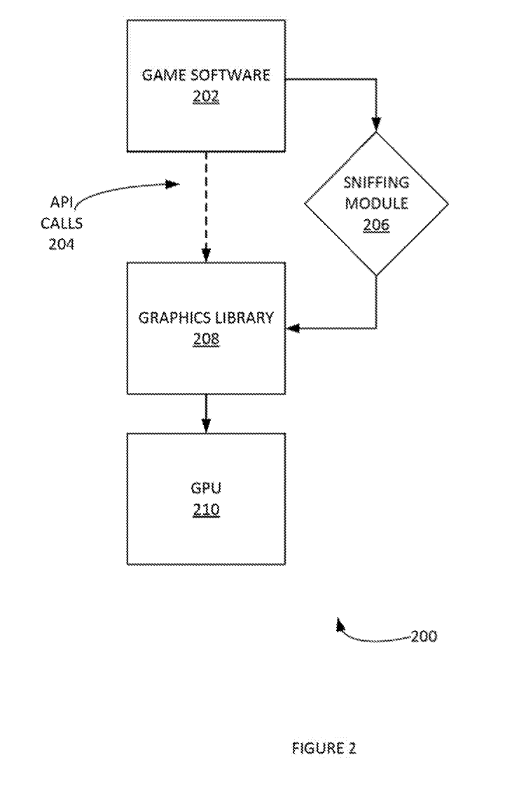

FIG. 2 illustrates an example system 200 for implementing a sniffing module (e.g. sniffing module 110), according to some embodiments. Game software 202 can send graphics data to GPU 210 (e.g. a graphics card). System 200 can send the graphics data using API calls 204 to graphics library(s) 208 (e.g. DirectX, OpenGL, etc.). Graphics library 208 can include various standard API interfaces. Sniffing module 206 can include the same API interface as graphics library 208 (e.g. DirectX/OpenGL libraries, etc.). In some embodiments, system 200 can include a user install (e.g. overwrite) of the sniffing module 206 over the default libraries. Sniffing module 206 can intercept/sniff/capture the data being sent to GPU 210. After copying the necessary data, sniffing module 206 can then forward the data to a graphics library(s) 208 for rendering to the player/caster. System 200 can stream pre-GPU data instead of post-GPU data (e.g. video produced by graphics board). Various processes provided infra are utilized to implement the streaming of pre-GPU data.

### Example Methods

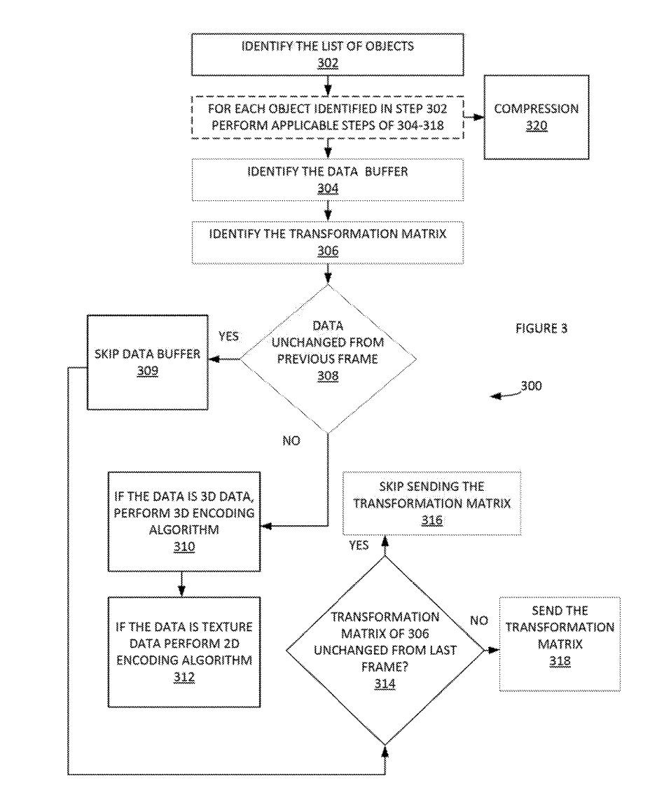

FIG. 3 illustrates an example process 300 for data reduction, according to some embodiments. As noted supra, game software can communicate data (e.g. video game related graphics data) to a GPU. In some examples, this can be performed at a frame rate about 60-120 fps (frame per second). Sometimes, the data can remain the same, only the view angle (e.g. of the player) and the coordinates of each object may change.

With every frame captured, in step 302, process 300 can identify a list of objects (3D objects, textures, etc.). For each object in the list generated by step 302, process 300 can perform various steps 304 through 318 depending on factors such as those provided infra. In step 304, process 300 can identify a data buffer (e.g. vertex coordinates and/or image texture) associated with this object in this frame and the previous frame. In step 306, process 300 can identify the transformation matrix associated with the object in a present frame and/or a previous frame. In step 308, it can be determined if the data is unchanged from the previous frame. If yes, then in step 309, process 300 can skip sending the data buffer (e.g. to reduce redundancies). If no (e.g. the data is changed from the last frame), then in step 310, process 300 can, if the data is 3D data, perform a 3D encoding algorithm and send out the encoded data. In step 312, if the data is texture data (e.g. 20 data), process 300 can perform a 2D encoding algorithm to extract the differences, and then send out only the differences. It is noted that process 300 need not perform both steps 310 and 312. In some embodiments, either one can be performed depending on the type of data (e.g. 3D data or 2D data, etc.).

In step 314, process 300 can determine if the transformation matrix of step 306 is unchanged from the last frame. If yes, in step 316, process 300 can skip the sending the transformation matrix. If no, then in step 318, process 300 can send out the transformation matrix. It is noted that after calculating the data above, process 300 can compress the data once again using various compressing algorithms (such as, Inter alia, ZIP/LHA) before sending out via network to the streaming server.

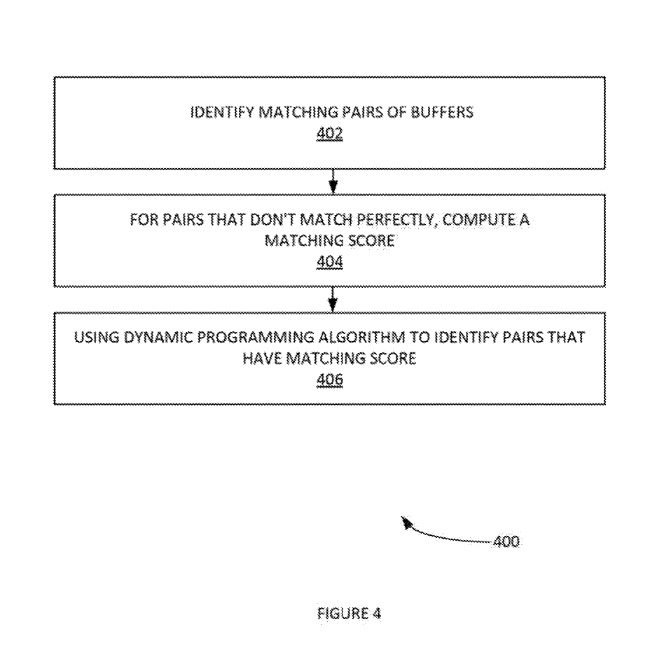

FIG. 4 illustrates an example process 400 for identifying a list of objects, according to some embodiments. It is noted that video game software can draw many objects in a frame. Each object can include static objects (e.g. a video-game building, etc.), moving objects (e.g. video-game characters, etc.) and/or textures (e.g. video-game sky, video-game skin, video-game grass, etc.). Process 400 can identify the data corresponding to an object are, inter alia: API calls; data transfer between a pair of API calls (e.g. glBegin( ), glEnd( ) in OpenGL and/or BeginScene( ) . . . EndScene( ) in DirectX, etc.); data in the parameters of API call (e.g. CreateVertexBuffer( )); data buffer in parameters of API call (e.g. DrawPrimitives( ), etc.). In some example embodiments, a data buffer identified as provided above is called “data buffer associated with the object” in the current frame.

Process 400 can identify a data buffer corresponding to an object in the current frame (e.g. as provided herein). Process 400 can identify which data buffer in the previous frame corresponding this data buffer (belong to the same object). The data buffer of the same object may change from frame to frame when the object animates. In one example, in step 402, process 400 can identify matching pairs of buffers (e.g. from current and previous frame). For example, process 400 can compute a hash code for each buffer, and determine the buffer that has the matching hash code.

In step 404, process 400 can compute a matching score for pairs that don't match perfectly. For example, process 400 can use a distance function between vectors. For example, process 400 can use a matching score >0.95. Process 400 can run a dynamic programming algorithm run in O(n). In step 406, process 400 can use dynamic programming algorithm to identify pairs that have a matching score.

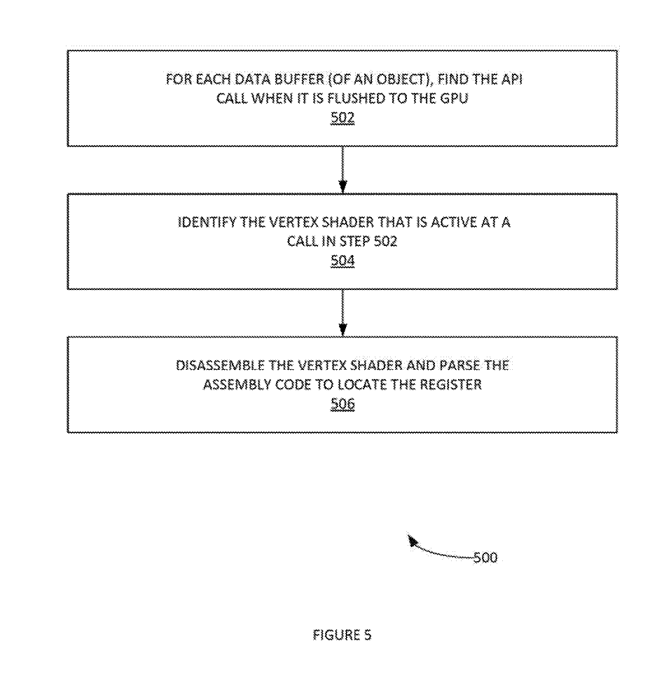

FIG. 5 illustrates an example process 500 for identifying a transformation matrix, according to some embodiments. In step 502, for each data buffer (of an object), process 500 can find the API call when it is flushed to the GPU (e.g. using API calls like DrawPrimitive( ), glFlush( ), etc.). In step 504, process 500 can identify the vertex shader that is active at a call in 502. In step 506, process 500 can implement an assembly of the vertex shader and parsing of the assembly code to locate the register (e.g. or offset in the parameter constant buffer of the shader, etc.). The register can correspond to “world matrix”, “model matrix”, or “model view matrix”, etc.

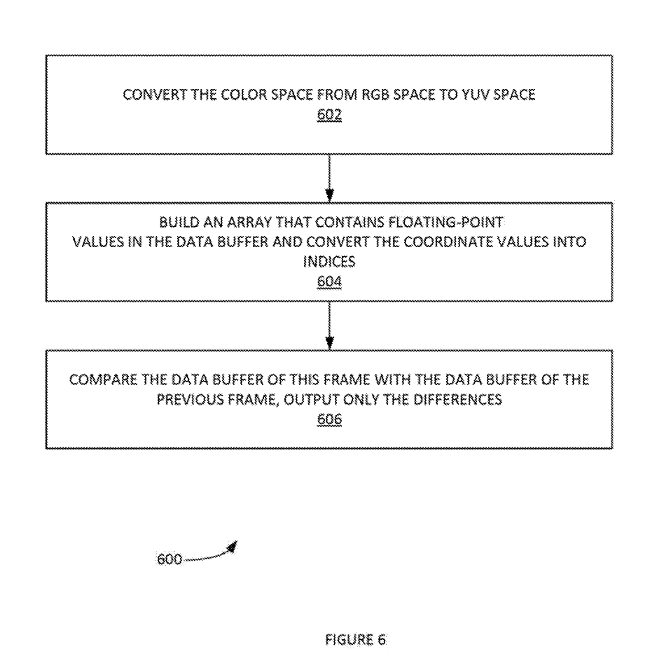

FIG. 6 illustrates an example process 600 of a 3D encoding algorithm, according to some embodiments. In step 602, process 600 can convert the color space from RGB space to YUV space. In step 604, process 600 can build an array that contains floating-point values in the data buffer and convert the coordinate values into indices (e.g. to a value array, etc.). The value array can use takes one to two (1-2) bytes to index. Step 604 can be implemented for the coordinates that can share the same floating-point value. In step 606, process 600 can compare the data buffer of the present frame with the data buffer of the previous frame, output the differences. If the information for differences occupies more space than the original data buffer, than process 600 can output the original data buffer.

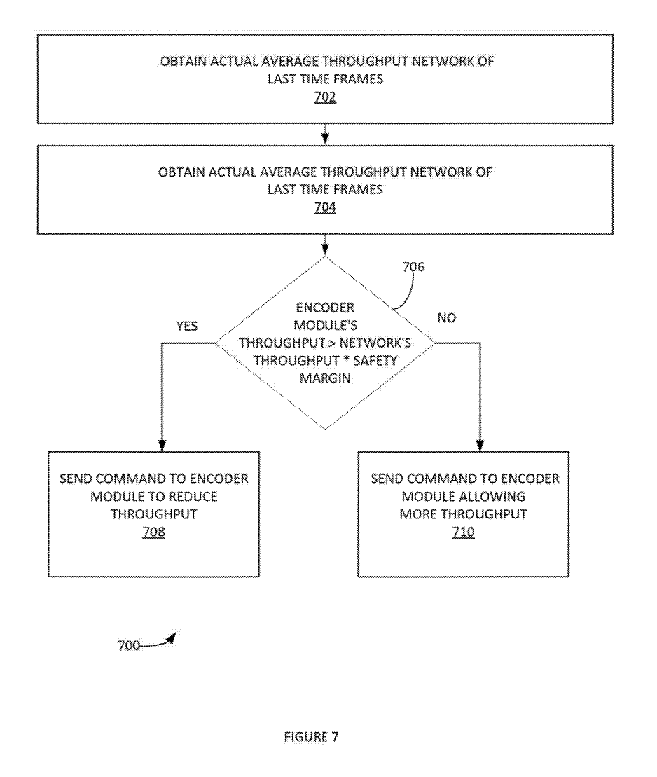

FIG. 7 illustrates an example of a transmittal-module throughput control process 700, according to some embodiments. A transmitter module (e.g. transmitter module 114) can adjust the amount of data (e.g. the throughput bitrate, etc.) according to an actual bandwidth between a caster's computing device and the server. In step 702, process 700 can obtain an average throughput of a computer network of a last time frame(s). In step 704, process 700 can calculate an average throughput of an encoder module (e.g. encoder module 112) of the last time frame(s). In step 706, process 700 can determine if the encoder module's throughput is greater than the product of the network's throughput and a specified safety margin.

If ‘yes’, then process 700 can send a command to the encoder module to reduce throughput in step 908. It is noted that when receiving a ‘reduce throughput’ command, an encoder module can skip some frames at a certain rate. The encoder module can also increase this rate until the data throughput is lower than the expected throughput specified in the command. It is noted, however, when skipping a frame, the encoder module can skip the skippable data, while still outputting the un-skippable data.

If ‘no’, then process 700 can send a command to the encoder module to allow more throughput. It is noted that when receiving an ‘allowing more throughput’ command, the encoder module can reduce the rate of frame-skipping until the data throughput reaches the expected throughput specified in the command.

As discussed supra, skippable data and un-skippable data parameters can be used to adjust the data throughput. Skippable data can be skipped without affect the rendering process of subsequent frames. Some examples of skippable data include, inter alia: vertex buffer, texture, API calls for rendering the current frame (e.g. glFlush, DrawPrimitives, etc.), etc. Some examples of un-skippable data Include data that cannot be skipped because contains information necessary for rendering subsequent frames (e.g. shader programs, constant buffer settings, etc.).

A streaming module can fill out the data omitted by the culling logic of the game software. A streaming module can multicast to multiple viewers. A streaming module can implement handling for viewers joining from the middle of the stream as well.

Culling can be the logic performed by video game software to omit (e.g. not sending to GPU, etc.) objects that are not visible from a player's view. Culling can be an issue when providing an immersive experience for viewers from a view angle different from a given player's view.

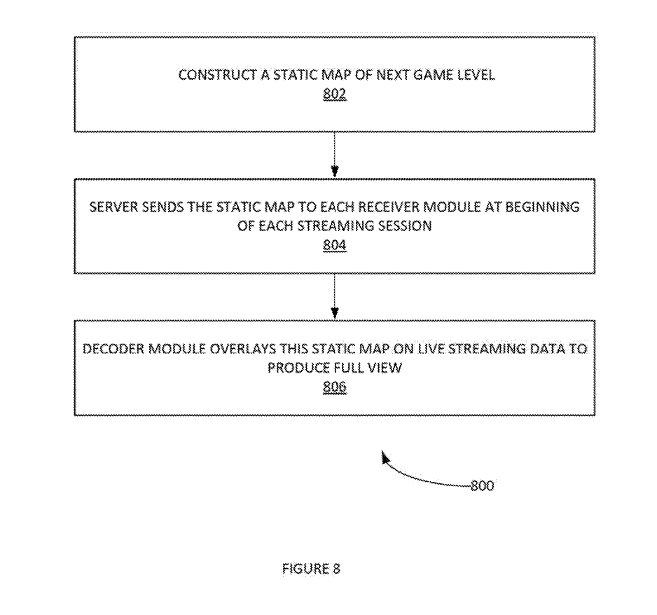

FIG. 8 illustrates an example process 800 that implements a culling solution in a video game, according to some embodiments. In step 802, process 800 can construct a static map of a next game level ahead of a current game level. Step 802 can be implemented once for each game. Process 800 can place a player in a spectator mode with no other player. The player can then move (e.g. walk, run, fly, etc.) around the map levels of the video game. Using the data captured in this mode, process 800 can then construct a map of the whole using map construction algorithm. This map can contain static objects (e.g. objects not moving during the game). In step 804, process 800 (e.g. using a server) can send this map to each receiver module (and subsequently to a decoder module) at the beginning of each streaming session. In step 806, process 800 can (e.g. using a decoder module) overlay this static map on the live streaming data to produce a full view.

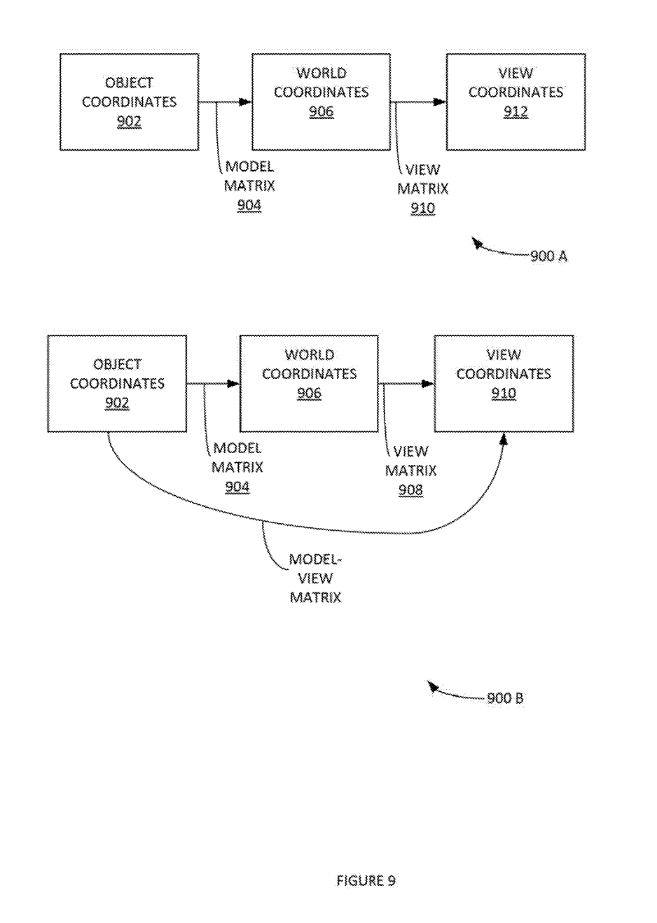

FIG. 9 illustrates example map construction process(es) 900 A-B, according to some embodiments. A map can be a collection of the static objects of a game level in world coordinates. If the coordinates associated with objects sent to a GPU are already world coordinates, process 900 can collect all of them over all frames. Process 900 can remove same objects (e.g. object that are sent twice or more). This can be used to generate a map. When the coordinates sent to GPU are not world coordinates, but are object coordinates, process 900 can implement other steps. Object coordinates 902 can be coordinates with the origin (0,0,0) at a specific point (e.g. the center) of each object. World coordinates 906 can be coordinates with the origin at a specific point (e.g. the center) of the level map. View coordinates 910 can be coordinates with the origin at a specific point (e.g. in front) of a digital camera. View coordinates can be the coordinates used to display on monitor or VR headset. These three type of coordinates can be the coordinates can be converted to each other using model matrix 904 and view matrix 908 (e.g. using process 900 A).

An example process of using world coordinates to construct a map is now provided. When the world coordinates are sent to the GPU the map can be constructed. When only the object coordinates are sent to the GPU, then the game software can send a model matrix and a view matrix to the GPU. The process can then capture the model matrix and perform the calculation to construct a world coordinates. For example, the following equation can be used to related the world coordinates to the model matric and object coordinates: World coordinates=Model matrix*Object coordinates. In some case (e.g. process 900 B), the game software may only send a ModelView matrix (and not the Model matrix and View matrix separately). The ModelView matrix can be the product of the Model matrix and the View matrix (e.g. as provided in the following relation ModelView matrix=Model matrix*View matrix). Accordingly, the process can extract Model matrix out of the ModelView matrix.

One example method of extracting a Model matrix from a ModelView matrix is now provided. It is noted that, in some examples, the Model matrix may be the same for the same static object in all frames (but can vary with different objects). The View matrix can be the same for all objects in a single frame (but can vary with different frames).

Accordingly, the process can denote MV(a,0) as the captured ModelView matrix of object a at time frame 0. MV(a, 1) can denote the captured ModelView matrix of object a at time frame 1. MV(b, 0), MV(b, 1) can denote object b at time frame 0, 1. The process can calculate M(a), M(b), which is the Model matrix for object a and object b where MV(a,0)=M(a)*V(0). The process can use the following relation for this: MV(b,0)=M(b)*V(0). Note that, based on the (Observations), Model matrix M only depends on the objects (M(a), M(b)), and View matrix V only depends on the time frame (V(0), V(1), . . . V(n)).

Accordingly, there are the following relations:

MV(a,0)=M(a)*V(0)

MV(b,0)=M(b)*V(0)

MV(a,1)=M(a)*V(1)

MV(b,1)=M(b)*V(1)

where MV( . . . , . . . ) are known (captured at GPU), and M(a), M(b), V(0), V(1) are unknown.

There are four (4) equations for four (4) unknowns, so the process can calculate the unknowns. It is noted that this process can be extended to a larger number (n) of objects in two (2) time frames. With 2n equations for (n+2) unknowns, the process can solve the unknown variable values (e.g. given that the actual Model and View matrices exist). It is noted that the process can assume that both V(0) and V(1) are different. Therefore, the process can capture enough time frames of which the V values are different and use these.

Another process can manage multicasting to multiple viewers. Multicasting can include streaming implementation of various existing streaming services. The multicasting process can handle user login/logout. The multicasting process can handle streaming session initiation. The multicasting process can handle multiple streaming sessions. The multicasting process can handle session termination. The multicasting process can use various streaming functionalities (e.g. FFMPEG). The multicasting process can handle users joining from the middle of a streaming session.

A map-storage process can be implemented. The map-storage process can store the map. In some embodiments, a map can be a collection of objects with world coordinates. The map-storage process can remove redundancies (e.g. when the same object with the same world coordinates is stored more than twice). The map-storage process can manage a response to a query. For example, the map-storage process can return the map within a specified range of space.

A receiver module (e.g. receiver module 122) can be provided. The receiver module can receive the streaming data from streaming server. In some embodiments, the protocol for controlling the streaming parameters would be similar to extant streaming protocols.

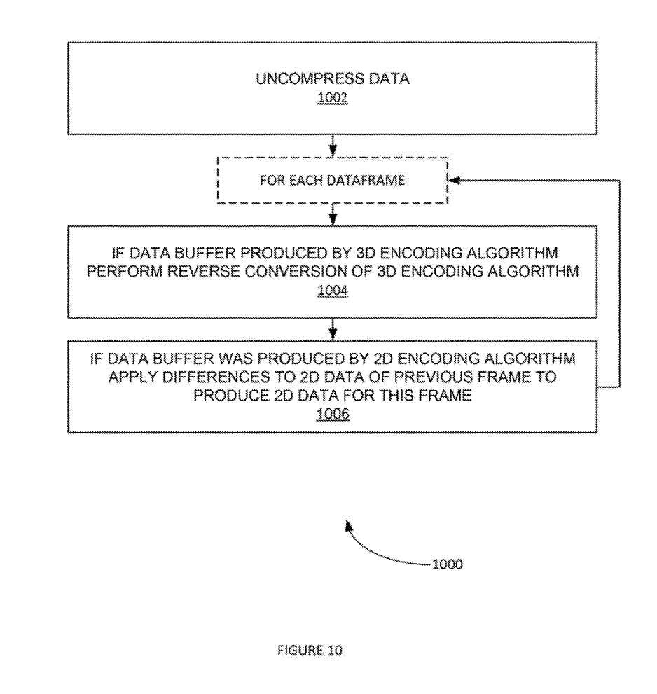

A decoder module (e.g. decoder module 124) can be provided. The decoder module can recover the data encoded by the encoder module. The decoder module can produce data for high frame rate display (e.g. great than sixty (60) fps) from low frame-rate data. The decoder module can send the data to GPU to render for the viewer. FIG. 10 provided an example process 1000 of decoding data, according to some embodiments. In some examples, process 1000 can implement a data reduction algorithm. In step 1002, process 1000 can uncompress data (e.g. using ZIP/LHA algorithm, etc.). Process 1000 can implement steps 1004 through 1006 for each data frame. In step 1004, if the data buffer was produced by 3D Encoding algorithm (e.g. as determined by checking a flag), process 1000 can perform the reverse conversion of 3D encoding algorithm. In step 1006, if the data buffer was produced by 2D Encoding algorithm, process 1000 can apply the differences to the 2D data of previous frame to produce the 2D data for this frame.

A data-frame production process can be provided. The data-frame production process can produce an additional data frame. The data-frame production process can change the view angle (e.g. setting view matrix) to the viewer's new angle. The data-frame production process can flush the objects (e.g. using the data buffer in the previous frame) again to the GPU. The data-frame production process can perform the steps to produce additional frames at necessary timing.

Additional Exemplary Computer Architecture and Systems

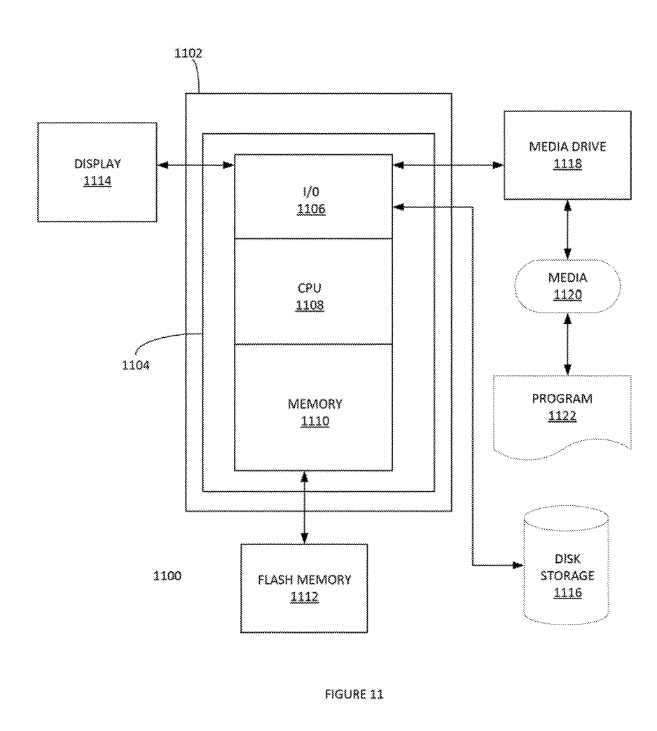

FIG. 11 depicts an exemplary computing system 1100 that can be configured to perform any one of the processes provided herein. In this context, computing system 1100 may include, for example, a processor, memory, storage, and I/O devices (e.g., monitor, keyboard, disk drive, Internet connection, etc.). However, computing system 1100 may include circuitry or other specialized hardware for carrying out some or all aspects of the processes. In some operational settings, computing system 1100 may be configured as a system that includes one or more units, each of which is configured to carry out some aspects of the processes either in software, hardware, or some combination thereof.

FIG. 11 depicts computing system 1100 with a number of components that may be used to perform any of the processes described herein. The main system 1102 includes a motherboard 1104 having an I/O section 1106, one or more central processing units (CPU) 1108, and a memory section 1110, which may have a flash memory card 1112 related to it. The I/O section 1106 can be connected to a display 1114, a keyboard and/or other user input (not shown), a disk storage unit 1116, and a media drive unit 1118. The media drive unit 1118 can read/write a computer-readable medium 1120, which can contain programs 1122 and/or data. Computing system 1100 can include a web browser. Moreover, it is noted that computing system 1100 can be configured to include additional systems in order to fulfill various functionalities. Computing system 1100 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

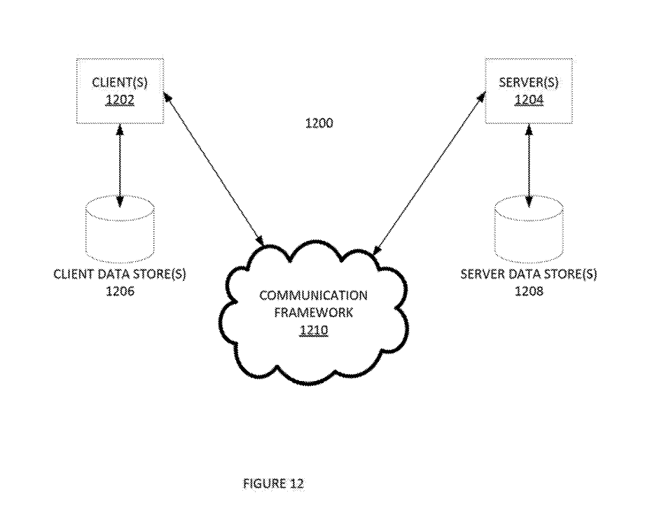

FIG. 12 is a block diagram of a sample-computing environment 1200 that can be utilized to implement various embodiments. The system 1200 further illustrates a system that includes one or more client(s) 1202. The client(s) 1202 can be hardware and/or software (e.g., threads, processes, computing devices). The system 1200 also includes one or more server(s) 1204. The server(s) 1204 can also be hardware and/or software (e.g., threads, processes, computing devices). One possible communication between a client 1202 and a server 1204 may be in the form of a data-packet adapted to be transmitted between two or more computer processes. The system 1200 includes a communication framework 1210 that can be employed to facilitate communications between the client(s) 1202 and the server(s) 1204. The client(s) 1202 are connected to one or more client data store(s) 1206 that can be employed to store information local to the client(s) 1202. Similarly, the server(s) 1204 are connected to one or more server data store(s) 1208 that can be employed to store information local to the server(s) 1204. In some embodiments, system 1200 can instead be a collection of remote computing services constituting a cloud-computing platform.

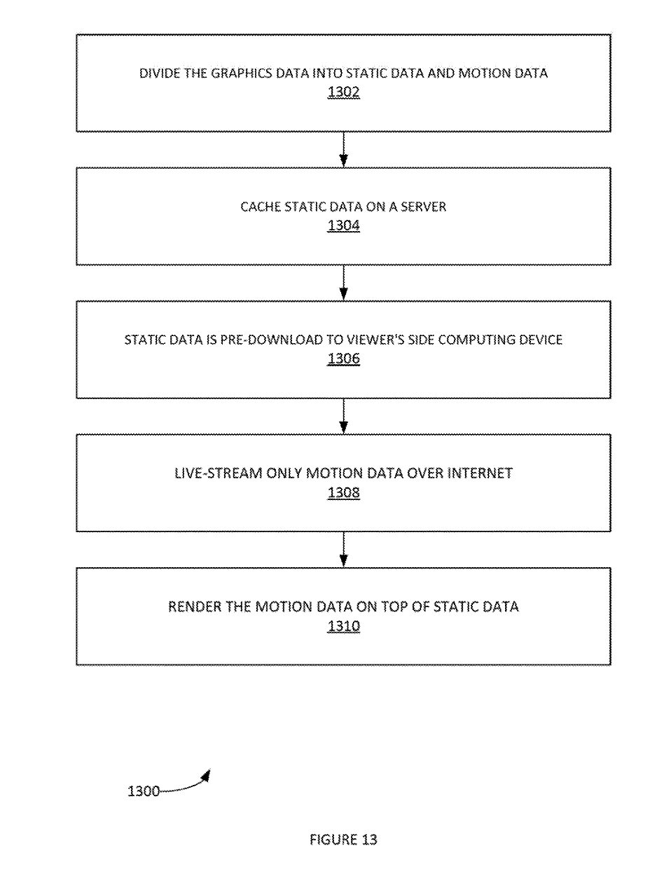

FIG. 13 illustrates an example process 1300 for data reduction in a graphics data stream, according to some embodiments. In step 1302, process 1300 can divide the graphics data into static data and motion (e.g. dynamic) data. As used herein, static data can include objects with positions that do not change relative to the map. Example static data objects include, for example, buildings, trees, etc. Motion data can include objects with positions or shapes that change relative to the map (e.g. characters, fire, water, etc.). Since static data does not change between game sessions, process 1300 can cache static data on a server in step 1304. The static data can be pre-download it to viewer's (e.g. player, caster, etc.) side computing device in step 1306. In step 1308, process 1300 can live-stream only motion data (which can be smaller) over Internet. In step 1310, process 1300 can render the motion data on top of static data (e.g. already downloaded to viewer's side) to re-produce the 3D scene.

In one example, the static data can occupy a large part (e.g. eighty to ninety percent (80-90%), etc.) of the data sent that is communicated to a GPU and/or sniffed by a sniffer module (e.g. snigger module 110, etc.). By removing static data before streaming, and rendering static data from cache at viewer's side, we can easily compress the raw data to about 1/10 the original size.

It is also noted that since the static data is unchanged during the play of the video game), process 1300 can merge different parts of a static scene (e.g. partly available at different time of the game) to a whole complete map scene.

Additionally, a complete three-hundred and sixty (360) degree view for viewers even if the current 3D live data is limited to player's FOV. The complete three-hundred and sixty (360) degree view (outside player's FOV) can show only static scene, and not contain motion data (e.g. characters, etc.).

The complete three-hundred and sixty (360) degree view can be used for the completeness of the scene when the viewers experience virtual reality (VR) for example. The objects in 3D scene can have several associated assets, such as, Inter allo: the vertex buffer, the texture, the shader (e.g. vertex shader, pixel shader, etc.). These assets can be available in the sniffed GPU data. The shaders can be available in a bytecode format and/or any other format readable to human experts.

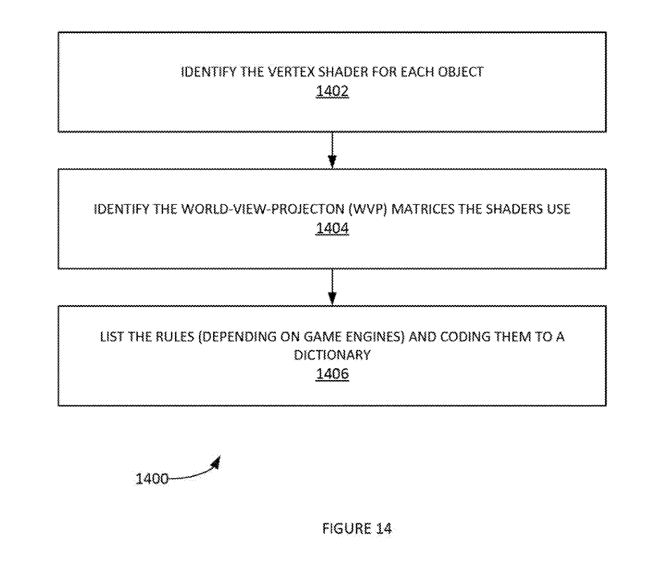

FIG. 14 illustrates an example process 1400 for recognizing static data and motion data, according to some embodiments. In step 1402, process 1400 can identify the vertex shader for each object. In step 1404, process 1400 can identify the world-view-projection (WVP) matrices the shaders use.

It is noted that there are several fixed rules for each game engine. Analysis can be implemented to determine these rules. For example, for static data, one (1) vertex shader can be associated with one (1) vertex buffer and one (1) WVP matrix. For motion data one (1) vertex shader can be associated with multiple WVP matrices (e.g. animation matrices, etc.) and/or multiple vertex buffers (e.g. for particle effects like wind, fire, etc.). In this way, process 1400 can differentiate that a particular shader is a shader for a static object or a shader for motion data.

In step 1406, process 1400 can list the rules (e.g. depending on the identity of a currently used game engine) and code them to a dictionary. Accordingly, process 1400 can detect static and motion data automatically in real-time from shaders in sniffed data.

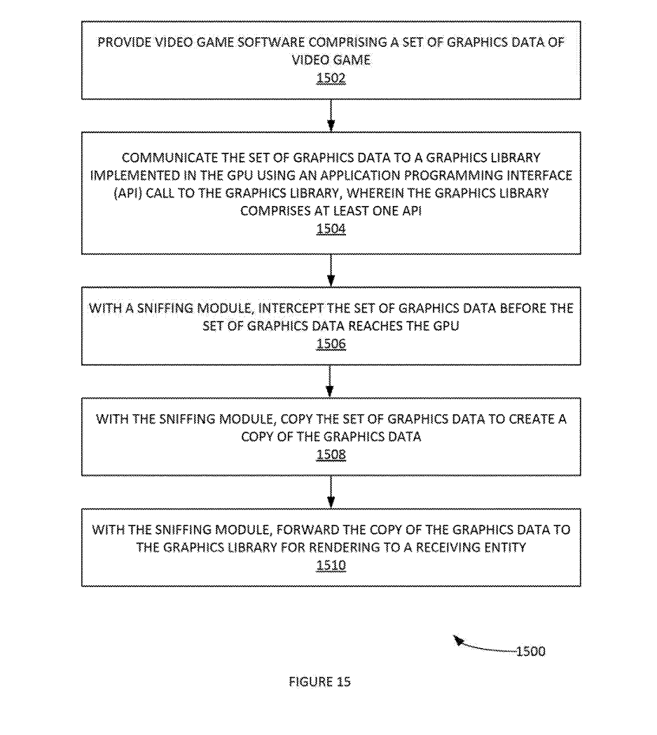

FIG. 15 illustrates an example process 1500 for sniffing graphic data, according to some embodiments. In step 1502, process 1500 can provide video game software comprising a set of graphics data of video game. In step 1504, process 1500 can communicate the set of graphics data to a graphics library using an application programming interface (API) call to the graphics library, wherein the graphics library comprises at least one API. In step 1506, process 1500 can, with a sniffing module, intercept the set of graphics data before the set of graphics data reaches the GPU. In step 1506, process 1500 can, with the sniffing module, copy the set of graphics data to create a copy of the graphics data (e.g. pre-GPU data). In step 1510, process 1500 can, with the sniffing module, forward the copy of the graphics data to the graphics library for rendering to a receiving entity.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A data sniffing method comprising:
providing a video game software comprising a set of graphics data of a video game;
communicating the set of graphics data to a graphics library using an application programming interface (API) call to the graphics library, wherein the graphics library comprises at least one application API interface; and
providing a sniffing module, wherein the sniffing module:
intercepts the set of graphics data before the set of graphics data reaches the GPU,
copies the set of graphics data to create a copy of the graphics data, and
forwards the copy of the graphics data to the graphics library for rendering to a receiving entity.

2. The GPU data sniffing method of claim 1, wherein the sniffing module copies only a specified portion of the set of graphics.

3. The GPU data sniffing method of claim 1, wherein the receiving entity comprises a game player's computing device.

4. The GPU data sniffing method of claim 3, wherein the GPU streams the copy of the graphics data instead of the set of graphics data.

5. The GPU data sniffing method of claim 4, wherein the copy of the graphics data comprises 3D graphics data.

6. The GPU data sniffing method of claim 5 further comprising:
culling the 3D graphics data to the field-of-view (FOV) of the player in the video game.

7. The GPU data sniffing method of claim 6 further comprising:
retaining the 3D graphics data of angles outside the player's FOV.

8. The GPU data sniffing method of claim 7, wherein the 3D graphics data of angles outside the player's FOV is rendered for viewing by the player when it is detected that the FOV has changed to view the area that was outside the player's FOV.

9. The GPU data sniffing method of claim 1, wherein the receiving entity comprises a caster's computing device.

10. The GPU data sniffing method of claim 1, wherein the sniffing module comprises:
divides the copy of the graphics data into a static data and a motion data;
cache the static data on a server;
live-stream the motion data; and
render, in a player's side computing system, the motion data on top of static data to re-produce the 3D scene of the video game.

11. The GPU data sniffing method of claim 10, wherein the static data comprises a set of graphic objects with positions that do not change relative to a map of the video game.

12. The GPU data sniffing method of claim 10, wherein the motion data comprises another set of graphic objects with positions that change relative to a map of the video game.

13. A computing system for implementing a data sniffing method comprising:
a processor, in the mobile device, configured to execute instructions;
a memory containing instructions when executed on the processor, causes the processor to perform operations that:
provide a video game software comprising a set of graphics data of a video game;
communicate the set of graphics data to a graphics library using an application programming interface (API) call to the graphics library, wherein the graphics library comprises at least one application API interface; and
provide a sniffing module, wherein the sniffing module:
intercepts the set of graphics data before the set of graphics data reaches the GPU,
copies the set of graphics data to create a copy of the graphics data, and
forwards the copy of the graphics data to the graphics library for rendering to a receiving entity.

14. The computing system of claim 13, wherein the sniffing module copies only a specified portion of the set of graphics.

15. The computing system of claim 13, wherein the receiving entity comprises a game player's computing device.

16. The computing system of claim 15, wherein the GPU streams the copy of the graphics data instead of the set of graphics data.

17. The computing system of claim 16, wherein the copy of the graphics data comprises 3D graphics data.

18. A data sniffing method comprising:
providing a sniffing module operative in a computer processing unit (CPU), wherein the sniffing module:
intercepts a set of graphics data before the set of graphics data reaches a graphics processing unit (GPU),
copies the set of graphics data to create a copy of the graphics data, and
forwards the copy of the graphics data to the graphics library for rendering to a receiving entity.
